(19) United States
(12) Patent Application Publication
(10) Pub. No.: US 2022/0321045 A1
(43) Pub. Date: Oct. 6, 2022

(54) METHOD FOR DETERMINING A ROTOR POSITION OF AN ELECTRIC MOTOR OF A POWER TOOL AND POWER TOOL

(71) Applicant: Festool GmbH, Wendlingen (DE)

(72) Inventors: Tobias Hofmann, Kirchheim/Teck (DE); Michael Thüringer, Großbettlingen (DE)

(21) Appl. No.: 17/634,109

(22) PCT Filed: Jul. 21, 2020
(86) PCT No.: PCT/EP2020/070557

§ 371 Date: Feb. 9, 2022

(30) Foreign Application Priority Data
Aug. 9, 2019 (DE) 10 2019 211 975.1

(51) Int. Cl. H02P 23/14; B25F 5/00

(52) U.S. Cl. CPC H02P 23/14; B25F 5/00

(57) ABSTRACT

A method for determining a rotor position of an electric motor (2) of a power tool (10), in particular an electric screwdriving tool, including the steps of: checking (S4) whether a first electric motor current (I1) is below a threshold value (SW), and in response to the check indicating that the first electric motor current (I1) is below the threshold value (SW), determining a rotor position of the electric motor (2) based on the first electric motor current (I1) and/or a second electric motor current.

The invention relates to a method for determining a rotor position of an electric motor of an electric power tool, in particular an electric screwdriving tool.

EP0579694B1, EP1051801B1, EP1746718B1 and DE102016222754A1 each describe methods for detecting a rotor position based on an electric motor current. The methods are based on a dependence of a winding inductance of the electric motor on the rotor position. A change in the rotor position leads to a change in the winding inductance, which in turn leads to a change in the electric motor current.

A detection of the rotor position based on the electric motor current shall also be referred to as sensorless detection of the rotor position.

It is an object of the invention to provide a method that enables reliable determination of the rotor position in an efficient manner.

The object is solved by a method according to claim 1. The method comprises the steps of: checking whether a first electric motor current is below a threshold value, and in response to the check indicating that the first electric motor current is below the threshold value, determining a rotor position of the electric motor based on the first electric motor current and/or a second electric motor current.

Since the detection of the rotor position is determined on the basis of an electric motor current—i.e. in particular without sensors—there is no need for a corresponding sensor system, for example a transducer, to detect the rotor position. Expediently, the power tool does not comprise any sensors for detecting, in particular directly detecting, the rotor position. In particular, within the method, no sensors are used for detecting, in particular directly detecting, the rotor position.

Furthermore, checking whether the electric motor current is below the threshold value can ensure that the determination of the rotor position is reliable. The electric motor current is expediently used as an indicator of the magnetic saturation of the electric motor. When the electric motor is magnetically saturated, the dependence of the winding inductance on the rotor position is usually very small or no longer present. In the case of magnetic saturation of the electric motor, it is therefore generally no longer possible to reliably infer the rotor position from the electric motor current (which is dependent on the winding inductance).

Conventionally, to avoid this problem, the electric motor is sized so that magnetic saturation does not occur during intended operation, thus avoiding that the detection of the rotor position based on electric motor current is impaired by magnetic saturation.

In the present method, magnetic saturation is expediently permitted during the intended operation. Accordingly, the electric motor of the power tool does not have to be dimensioned so large that no magnetic saturation occurs during the intended operation.

Nonetheless, a reliable detection of the rotor position can be performed with the power tool. By checking, before detecting the rotor position, whether the electric motor current is above the threshold, and by detecting the rotor position in response to the electric motor current being below the threshold, it can be expediently ensured that the detection of the rotor position is performed in a state in which there is no magnetic saturation of the electric motor and the detection of the rotor position is expediently not impaired. Thus, a reliable detection of the rotor position can be achieved in an efficient manner.

Expediently, the electric motor is operated in temporally successive, non-overlapping operating phases. In particular, the operating phases comprise a position determination phase in which the rotor position is determined and in which the first electric motor current is smaller than the threshold value. Expediently, the operating phases further comprise a torque phase in which the rotor position is not determined and in which the first electric motor current is greater than the threshold value. Expediently, in the torque phase, the power tool uses the rotor position determined in the position determination phase to control the electric motor.

Advantageous further embodiments are defined in the dependent claims.

The invention further relates to a power tool, in particular an electric screwdriving tool, having an electric motor. The power tool is configured to determine a rotor position of the electric motor based on an electric motor current. The power tool is configured to check whether a first electric motor current is below a threshold value, and in response to the check indicating that the first electric motor current is below the threshold value, to determine a rotor position of the electric motor based on the first electric motor current and/or a second electric motor current.

The invention further relates to a control device for a power tool having an electric motor. The control device is configured to check whether a first electric motor current is below a threshold value, and in response to the check indicating that the first electric motor current is below the threshold value, to determine a rotor position of the electric motor based on the first electric motor current and/or a second electric motor current.

Further exemplary details as well as exemplary embodiments are explained below with reference to the figures. Thereby shows

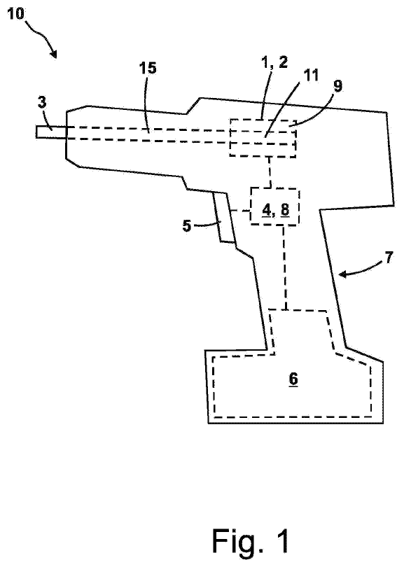

FIG. 1 a schematic representation of a power tool,

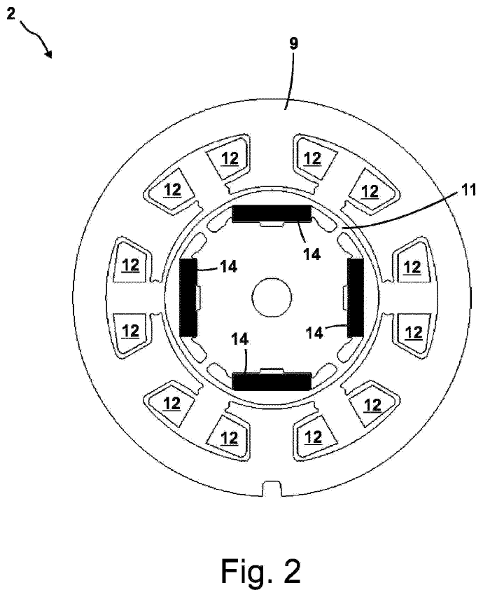

FIG. 2 a sectional view of an electric motor,

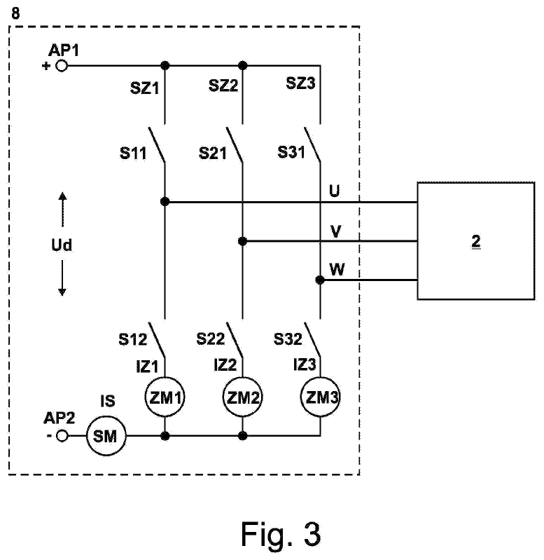

FIG. 3 a circuit diagram of a drive circuit,

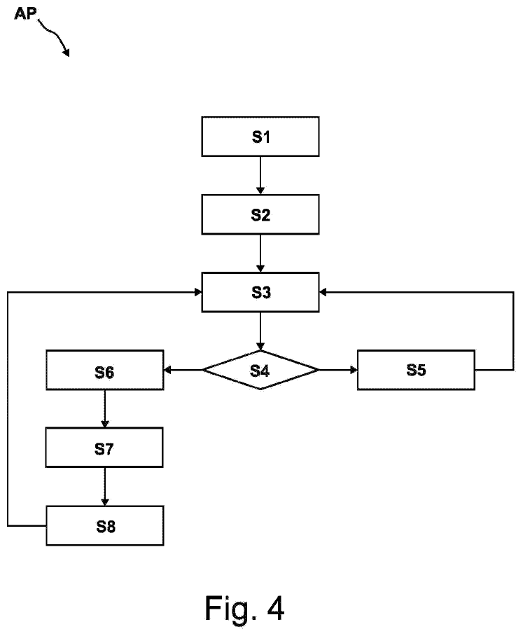

FIG. 4 a flowchart of a control procedure,

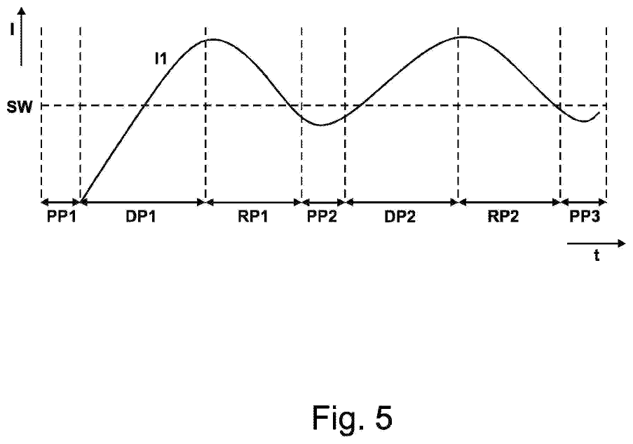

FIG. 5 a time course of an electric motor current.

FIG. 1 shows a power tool 10 according to an exemplary embodiment. The power tool 10 is exemplarily designed here as an electric screwdriving tool, in particular as a cordless screwdriver. Alternatively, the power tool 10 may be embodied as another power tool, in particular as a power tool having a rotating tool. For example, the power tool may be embodied as a saw, grinder, drill and/or router. In particular, the power tool 10 is a hand-held power tool. Alternatively, the power tool 10 may be a stationary or semi-stationary power tool.

The power tool 10 comprises an electric motor 2. The power tool 10 is configured to check whether a first electric motor current I1 is below a threshold value SW. An exemplary time course of the electric motor current I1 is shown together with the threshold value SW in FIG. 5. The power tool 10 is configured to determine a rotor position of the electric motor 2 based on the first electric motor current I1 and/or a second electric motor current in response to the check indicating that the first electric motor current I1 is below the threshold value SW. The second electric motor current comprises, for example, one or more of the branch currents IZ1, IZ2, IZ3 shown in FIG. 3 and/or the sum current IS shown in FIG. 3.

In particular, the power tool 10 is configured to perform the determination of the rotor position based on the first and/or second electric motor current in response to the check indicating that the electric motor current I1 is below the threshold value SW. Preferably, the power tool 10 is configured not to perform a determination of the rotor position based on the first and/or second electric motor current in response to the check indicating that the electric motor current I1 is above the threshold SW. In particular, the power tool 10 is configured to perform the determination of the rotor position based on the first and/or second electric motor current only if the check indicates that the electric motor current I1 is below the threshold value SW.

As mentioned at the beginning, the first electric motor current I1 serves as an indicator for the magnetic saturation of the electric motor 2. By determining the rotor position when the electric motor current I1 is below the threshold value SW—i.e. in particular when it can be assumed that there is no (significant) magnetic saturation—it can be ensured that the determination of the rotor position is not impaired by magnetic saturation of the electric motor 2.

Further exemplary details are explained below.

First, regarding the power tool:

The power tool 10 comprises an electric drive 1. The electric drive 1 comprises the electric motor 2. Optionally, the electric drive 1 further comprises a gearbox (not shown in the figures). The electric motor 2 is preferably designed as a brushless DC motor. In particular, the electric motor 2 is a three-phase synchronous motor with excitation by permanent magnets. Expediently, the electric motor 2 is an EC motor (electronically commutated motor).

The power tool 10 further comprises a tool 3, for example a screwing tool, which can be driven by the electric motor 2. In particular, the tool 3 can be rotated by the electric motor 2. Exemplarily, the tool 3 is coupled to the electric motor 2 via a shaft 15 (and/or the optional gearbox).

The power tool 10 expediently further comprises a control device 4 and an operating device 5. Optionally, the power tool 10 further comprises an energy storage 6, such as a rechargeable battery.

The control device 4 expediently comprises a computer unit, for example a microcontroller. The control device 4 is used in particular to perform the aforementioned check as to whether the first electric motor current I1 is below the threshold value SW and/or to determine the rotor position on the basis of the first and/or second electric motor current. The control device 4 expediently comprises a drive circuit 8 for providing the drive voltages for the electric motor 2. An exemplary embodiment of a drive circuit 8 is shown in FIG. 3.

The operating device 5 comprises a key, in particular a trigger key, as an example. Via the operating device 5, a user can expediently control the drive of the tool 3 by the electric motor 2, in particular with which speed and/or which torque the tool 3 is driven. The control device 4 is expediently configured to detect an actuation of the operating device 5 and to carry out the control of the electric motor 2 in accordance with the actuation.

The energy for operating the power tool 10, in particular the control device 4 and/or the electric motor 2, is expediently provided by the energy storage 6.

In an exemplary embodiment, the power tool 10 includes a handle 7 that allows the power tool 10 to be grasped and carried by a user, in particular with one hand.

Exemplarily, the power tool 10 comprises a housing in which the electric drive 1, the control device 4 and/or the energy storage 6 are arranged. Preferably, the operating device 5 is arranged on the outside of the housing. Expediently, the handle 7 forms part of the housing.

With reference to FIG. 2, an exemplary embodiment of the electric motor 2 will be discussed below:

The electric motor 2 comprises a stator 9 and a rotor 11. The stator 9 comprises a plurality of windings 12 distributed around the axis of rotation of the rotor 11. The rotor 11 includes a plurality of permanent magnets 14 distributed around the axis of rotation of the rotor 11.

The rotor 11 is preferably designed non radially symmetrical, in particular with regard to its magnetic properties. Depending on the rotor position of the rotor 11, the influence of the rotor on the inductances of the windings 12 changes. Expediently, the inductances of the windings 12 are respectively dependent on the rotor position of the rotor 11. By the term rotor position is meant in particular the rotational position of the rotor 11 with respect to its axis of rotation. According to an alternative embodiment, the rotor 11 is configured radially symmetrical.

Expediently, the windings 12 are energized via the drive circuit 8 in such a way that a rotating field is provided which rotates about the axis of rotation of the rotor 11 and, through interaction with the permanent magnets 14, drives the rotor 11 to rotate about its axis of rotation.

The stator 9 and/or the rotor 11 expediently comprise magnetizable, in particular ferromagnetic, material, for example iron. Above a certain current intensity of the currents flowing through the windings 12, the magnetizable material enters magnetic saturation. In magnetic saturation, the dependence of the inductances of the windings 12—and thus of the currents flowing through the windings 12—on the rotor position is reduced and/or eliminated.

The magnetic saturation of the electric motor 2, in particular of said magnetizable material of the stator 9 and/or rotor 11, is expediently indicated by the threshold value SW. Expediently, the threshold value SW corresponds to a current intensity of the first electric motor current I1 at which a magnetic saturation of the electric motor 2, in particular of said magnetizable material of the stator 9 and/or rotor 11, is given. The threshold value SW is expediently determined in advance and is stored in the power tool 10, in particular in the control device 4.

The first electric motor current I1 expediently comprises one, more, or all of the currents flowing through the windings 12. For example, the first electric motor current I1 is the sum of the currents flowing through the windings 12. In particular, the first electric motor current I1 is the sum of the currents flowing into or out of the windings 12.

With reference to FIG. 3, the control of the electric motor 2 will be discussed in more detail below:

FIG. 3 shows an exemplary design of the drive circuit 8. The drive circuit 8 is expediently designed as an inverter. The drive circuit 8 serves in particular to provide several drive signals for driving the electric motor 2, in particular the windings 12. Exemplarily, the drive circuit 8 provides three drive signals. Exemplarily, the drive circuit 8 has a first output U for providing a first drive signal, a second output V for providing a second drive signal and a third output W for providing a third drive signal.

The drive circuit 8 provides the drive signals expediently on the basis of a supply voltage Ud applied between two connection points AP1, AP2. The supply voltage Ud is expediently a DC voltage.

The three drive signals can also be referred to as phases. The drive signals are preferably voltage signals.

The drive circuit 8 comprises a respective circuit branch SZ1, SZ2, SZ3 for each of the outputs U, V, W as an example. The circuit branches SZ1, SZ2, SZ3 are each connected between the two connection points AP1, AP2. The circuit branches SZ1, SZ2, SZ3 are each designed as half bridges as an example. Each circuit branch SZ1, SZ2, SZ3 expediently comprises two respective switches—a first switch S11, S21, S31 and a second switch S12, S22, S32. The respective output U, V, W can be connected to the first connection point AP1 via the respective first switch S11, S21, S31 and to the second connection point AP2 via the respective second switch S12, S22, S33.

By controlling the first and second switches S11, S21, S31, S12, S22, S32, alternating signals, in particular alternating signals that are phase-shifted with respect to one another, can be provided as the drive signals in order to drive the rotor 11.

The power tool 10 is configured to detect the first electric motor current I1 and/or the second electric motor current. The first electric motor current I1 and/or the second electric motor current are currents flowing through one, several or all windings 12 of the electric motor 2. The first electric motor current I1 and the second electric motor current can be the same current or can be different currents.

Exemplarily, the first electric motor current I1 is the total current flowing through the windings 12. Exemplarily, this current is detected as the sum current IS flowing into the second connection point AP2. Alternatively or additionally, the total current can also be detected as a sum current IS flowing into or out of the first connection point AP1.

The power tool 10, in particular the drive circuit 8, exemplarily comprises a sum current measuring unit SM for detecting the sum current IS. The sum current measuring unit SM is connected between the second connection point AP2 and the second switches S12, S22, S32.

The first electric motor current I1 may further comprise one, more or all of the branch currents IZ1, IZ2, IZ3 flowing in the circuit branches SZ1, SZ2, SZ3. Expediently, the power tool 10 is configured to compare one, more, or all of the branch currents IZ1, IZ2, IZ3 to the threshold value SW, respectively, and to perform the rotor position determination in response to each compared branch current IZ1, IZ2, IZ3 being smaller than the threshold value SW.

The power tool 10, in particular the drive circuit 8, comprises exemplarily several branch current measuring units ZM1, ZM2, ZM3 for detecting the respective branch currents IZ1, IZ2, IZ3. The branch current measuring units ZM1, ZM2, ZM3 are each connected in a respective circuit branch SZ1, SZ2, SZ3.

As an alternative to the embodiment shown, in which an individual branch current measuring unit ZM1, ZM2, ZM3 is present for each circuit branch SZ1, SZ2, SZ3, there can also be fewer branch current measuring units than circuit branches. For example, there may be no branch current measuring unit for a circuit branch. The branch current of this circuit branch is then expediently calculated by the power tool 10, in particular on the basis of the other branch currents and the sum current.

In the following, the determination of the rotor position based on the first and/or second electric motor current will be discussed.

Expediently, the power tool 10 is configured to apply a test signal to the electric motor 2 and to determine the rotor position on the basis of the response of the first electric motor current and/or second electric motor current to the test signal. Expediently, the application of the test signal does not drive the rotor 11. Expediently, the application of the test signal comprises a sequence of switching states and/or voltage values for the outputs U, V, W, which are effected by controlling the first and second switches S11, S21, S31, S12, S22, S32.

Specific test signals for controlling the electric motor 2 for the purpose of determining the rotor position are described in the prior art mentioned at the beginning. In particular, test signals are known from the so-called “Inform method”. Expediently, the power tool 10 is configured to control the electric motor 2 with a test signal according to the Inform method.

In response to the test signal, the first and/or second electric motor current may change. The power tool 10 is configured to detect the first and/or second electric motor current and to determine the rotor position based thereon. Expediently, the power tool 10 detects, as the second electric motor current, the branch currents IZ1, IZ2, IZ3 and determines the rotor position on the basis of the branch currents IZ1, IZ2, IZ3, in particular on the basis of the temporal course and/or certain signal characteristics of the branch currents IZ1, IZ2, IZ3.

Alternatively or additionally, the power tool 10 detects as the second electric motor current two of the branch currents IZ1, IZ2, IZ3 and determines the rotor position based on the two detected branch currents, in particular based on the time course and/or certain signal characteristics of the two detected branch currents.

Alternatively or additionally, the power tool 10 detects the sum current IS as the second electric motor current and determines the rotor position on the basis of the sum current IS, in particular on the basis of the time course and/or certain signal characteristics of the sum current IS.

Concrete mathematical methods for determining the rotor position on the basis of branch currents are described in the prior art mentioned at the beginning. In particular, these mathematical methods are known from the Inform method. Expediently, the power tool 10 is configured to mathematically determine the rotor position according to the Inform method.

In particular, the power tool 10 is configured to perform a control, in particular a commutation, of the electric motor 2 on the basis of the determined rotor position. In particular, the power tool 10 is configured to perform sensorless commutation of the electric motor 2 using the determined rotor position. In particular, the power tool 10 is configured to provide the drive signals provided at the outputs U, V, W on the basis of the determined rotor position. Expediently, the power tool 10 provides the drive signals provided at the outputs U, V, W on the basis of the determined rotor position and on the basis of a user input entered by the operating device 5, for example a requested speed and/or a requested torque.

The power tool 10 is expediently configured to continue the control of the electric motor 2, in particular the commutation, on the basis of the last determined rotor position until a new determined rotor position is available. For example, if the first electric motor current I1 is above the threshold value SW, and the power tool 10 does not perform a determination of the rotor position for this reason at this time, the power tool 10 continues to use the last determined rotor position for the control of the electric motor 2 at this time. Expediently, by driving the electric motor 2 based on a determined first rotor position, the power tool 10 performs a rotation of the rotor 11 by 90 degrees electrically and then, if no new rotor position of the rotor 11 has been determined, continues driving based on the first rotor position. This may cause the rotor 11 to stop after the 90 degree rotation electrically until the power tool 10 has determined a new rotor position and performs control based on the new rotor position. For example, a rotation of 90 degrees electrically corresponds to a rotation of the rotor by 45 degrees mechanically for two pole pairs and 30 degrees mechanically for three pole pairs.

With reference to FIGS. 4 and 5, an exemplary control procedure AP for controlling the electric motor 2 will be discussed in more detail below. The control procedure is an example of a method for determining the rotor position of the electric motor 2 of the power tool 10.

The control procedure AP is expediently executed by the power tool 10, in particular by the control device 4.

The control procedure AP starts with an optional step S1, in which the rotor position is determined on the basis of the first and/or second electric motor current, expediently in a state in which the rotor 11 is not yet being driven and expediently not moving. After the rotor position has been determined, the optional step S2 is carried out, in which the electric motor 2 is started; i.e. in particular the first electric motor current I1 is increased to such an extent that the rotor 11 is being driven and expediently set in motion.

If the control procedure AP is started in a state in which the electric motor 2 is already running, steps S1 and S2 are not necessary and are expediently not present.

The control procedure AP continues with step S3, in which a drive of the electric motor 2, in particular a current supply to the windings 12, takes place in order to generate a torque that is applied to the tool 3. In step S3, the windings 12 can be energized to such an extent that the first electric motor current I1 rises above the threshold value SW or that the first electric motor current I1 remains below the threshold value SW.

Preferably, in step S3 the electric motor 2 is controlled on the basis of the rotor position determined in a previous step (for example S2, S5 or S8).

In step S4, it is checked whether the first electric motor current I1 is smaller than the threshold value SW. If the check indicates that the first electric motor current I1 is smaller than the threshold value SW, the control procedure continues with step S5, in which the rotor position is determined on the basis of the first and/or second electric motor current. Expediently, at the step S5 the electric motor 2, in particular the windings 12, is controlled with the test signal. Furthermore, at the step S5 expediently the branch currents IZ1, IZ2, IZ3 resulting in response to the test signal are detected and on the basis of these branch currents IZ1, IZ2, IZ3 the rotor position is determined. The control procedure AP then expediently returns to step S3.

If the check shows that the first electric motor current I1 is greater than the threshold value SW, the control procedure continues with steps S6 and S7.

Expediently, the power tool 10 is configured not to perform a determination of the rotor position based on the first and/or second electric motor current in response to the check indicating that the electric motor current I1 is above the threshold value SW. In particular, when the check indicates that the electric motor current I1 is above the threshold value SW, the power tool 10 is configured not to control the electric motor 2 with the test signal and/or not to detect the branch currents IZ1, IZ2, IZ3 resulting in response to the test signal and/or not to determine the rotor positions based on these branch currents IZ1, IZ2, IZ3. Accordingly, in steps S6 and S7, no determination of the rotor position is performed on the basis of the first and/or second electric motor current.

Expediently, the power tool 10 is configured to reduce the electric motor current I1 in response to the check indicating that the electric motor current I1 is above the threshold SW until the electric motor current I1 is below the threshold SW. In the control procedure AP, this is exemplified by stopping the driving of the electric motor 2 in the step S6. For example, the motor phases, in particular the drive signals, of the electric motor 2 are switched off. Exemplarily, the drive circuit 8 is switched so that the currents flowing in the windings 12 are reduced. For example, all first switches S11, S21, S31 are opened (i.e. set to “non-conducting”) and all second switches S21, S22, S32 are closed (i.e. set to “conducting”). Alternatively, all first switches S11, S21, S31 are closed and all second switches S21, S22, S32 are opened.

In step S7, it is waited, for example with the driving of the electric motor 2 still being stopped, until the first electric motor current I1 falls below the threshold value SW.

The power tool 10 is expediently configured to perform a determination of the rotor position based on the first and/or second electric motor current after the reduction of the first electric motor current I1 below the threshold value SW. The determination of the rotor position is carried out in step S8 as an example.

The control procedure then proceeds to step S3. Expediently, the power tool is configured to increase the first electric motor current I1 above the threshold value SW after a determination of the rotor position, for example within step S3.

With reference to FIG. 5, various phases that are passed through when the electric motor is controlled, in particular when the control procedure AP is carried out, will be explained below.

FIG. 5 shows a time course of the first electric motor current I1 together with successively performed operating phases of the power tool 10. The operating phases include, by way of example, position determination phases PP1, PP2, PP3, torque phases DP1, DP2 and reduction phases RP1, RP2.

Exemplarily, the operating phases are carried out one after the other in the sequence: position determination phase, torque phase, reduction phase. Expediently, the operating phases are repeated in the mentioned sequence several times, in particular continuously. In the example shown, the operating phases are performed one after the other in the sequence: first position determination phase PP1, first torque phase DP1, first reduction phase RP1, second position determination phase PP2, second torque phase DP2, second reduction phase RP2, third position determination phase PP3.

Expediently, the power tool 10 is configured to start with the first position determination phase PP1. In the first position determination phase PP1, the first electric motor current I1 is below the threshold value SW. The power tool 10 is configured to determine the rotor position based on the first and/or second electric motor current during the first position determination phase PP1.

In the first position determination phase PP1, step S2 in particular and optionally step S1 before that are carried out.

Expediently, the power tool 10 is configured to perform the first torque phase DP1 after the position determination phase and to increase the first electric motor current I1 above the threshold value SW during the first torque phase DP1. More expediently, during the first torque phase DP1, the power tool 10 is configured not to perform a determination of the rotor position based on the first and/or second electric motor current.

In particular, steps S3 and S4 are carried out in the first torque phase DP1.

Expediently, the power tool 10 uses the rotor position determined in the first position determination phase PP1 for controlling the electric motor 2 in the first torque phase DP1.

Expediently, the power tool 10 is configured to perform the first reduction phase RP1 after the first torque phase DP1 and to reduce the first electric motor current I1 below the threshold value SW during the first reduction phase RP1.

In the first reduction phase, steps S6 and S7 are carried out in particular.

Expediently, the power tool 10 then proceeds to the second position determination phase PP2, in particular when the power tool 10 has determined within a check that the first electric motor current I1 is smaller than the threshold value SW. The power tool 10 performs the second position determination phase PP2 in the same way as the first position determination phase PP1, and then proceeds with the subsequent operating phases in the manner explained above.

1. A method for determining a rotor position of an electric motor of a power tool, comprising the steps of: checking whether a first electric motor current is below a threshold value, and, in response to the check, indicating that the first electric motor current is below the threshold value, determining a rotor position of the electric motor based on the first electric motor current and/or a second electric motor current.

2. The method according to claim 1, wherein the first electric motor current exceeding the threshold value indicates a magnetic saturation of the electric motor.

3. The method according to claim 1, further comprising: checking whether the first electric motor current is above the threshold value, and in response to the check indicating that the first electric motor current is above the threshold value, not determining the rotor position based on the first electric motor current and/or the second electric motor current.

4. The method according to claim 1, further comprising: in response to the check, indicating that the first electric motor current is above the threshold value, reducing the first electric motor current until the electric motor current is below the threshold value.

5. The method according to claim 4, further comprising: after reducing the first electric motor current below the threshold value, determining the rotor position based on the first and/or second electric motor current.

6. The method according to claim 1, further comprising: after a determination of the rotor position, increasing the first electric motor current above the threshold value.

7. The method according to claim 1, wherein a position determination phase, a torque phase and a reduction phase are carried out successively when driving the electric motor.

8. The method according to claim 7, wherein the position determination phase is performed in response to the first electric motor current being below the threshold value, and within the position determination phase the rotor position is determined based on the first and/or second electric motor current.

9. The method according to claim 7, wherein the torque phase is performed after the position determination phase and within the torque phase the first electric motor current is increased above the threshold value, and within the torque position determination phase no determination of the rotor position is performed based on the first and/or second electric motor current.

10. The method according to claim 7, wherein after the torque phase the reduction phase is performed and within the reduction phase the first electric motor current is reduced below the threshold value.

11. The method according to claim 7, wherein the position determination phase, the torque phase and the reduction phase are repeated several times in succession in the stated order.

12. The method according to claim 1, wherein a control of the electric motor is carried out on the basis of the determined rotor position.

13. The method according to claim 1, wherein the electric motor is a brushless DC motor.

14. The method according to claim 1, further comprising: applying a test signal to the electric motor and determining the rotor position based on the response of the first and/or second electric motor current to the test signal.

15. A power tool, having an electric motor, the power tool being configured to check whether a first electric motor current is below a threshold value, and, in response to the check indicating that the first electric motor current is below the threshold value, to determine a rotor position of the electric motor on the basis of the first electric motor current and/or a second electric motor current.

16. (canceled)

17. A control device for a power tool having an electric motor, the control device being configured to check whether a first electric motor current is below a threshold value and, in response to the check indicating that the first electric motor current is below the threshold value, to determine a rotor position of the electric motor on the basis of the first electric motor current and/or a second electric motor current.

18. The method according to claim 1, wherein the power tool is an electric screwdriving tool.

19. The method according to claim 1, wherein a commutation of the electric motor is carried out on the basis of the determined rotor position.

20. The power tool according to claim 15, wherein the power tool is an electric screwdriving tool.
